(19) United States
(12) Patent Application Publication
(10) Pub. No.: US 2022/0207546 A1
(43) Pub. Date: Jun. 30, 2022

(54) DEMAND FORECASTING DEVICE

(71) Applicant: NTT DOCOMO, INC., Chiyoda-ku (JP)

(72) Inventors: Masato YAMADA, Chiyoda-ku (JP); Kenji SHINODA, Chiyoda-ku (JP); Yusuke FUKAZAWA, Chiyoda-ku (JP); Masatoshi KIMOTO, Chiyoda-ku (JP)

(73) Assignee: NTT DOCOMO, INC., Chiyoda-ku (JP)

(21) Appl. No.: 17/603,445

(22) PCT Filed: Apr. 14, 2020
(86) PCT No.: PCT/JP2020/016459

§ 371 Date: Oct. 13, 2021

(30) Foreign Application Priority Data
Apr. 16, 2019 (JP) 2019-077842

(51) Int. Cl. G06Q 30/02

(52) U.S. Cl. CPC G06Q 30/0205

(57) ABSTRACT

An object is to forecast a demand more flexibly. A demand forecasting device 1 that forecasts a demand in a first area, which is a predetermined area, includes a storage unit (10) configured to store area information regarding a second area, the second area being a predetermined area relevant to a demand of the first area, an acquisition unit (11) configured to acquire information on the number of people in the second area indicated by the area information stored in the storage unit (10), and a forecasting unit (12) configured to forecast a demand in the first area on the basis of the information on the number of people in the area acquired by the acquisition unit (11).

### TECHNICAL FIELD

One aspect of the present disclosure relates to a demand forecasting device that forecasts demand in a predetermined area.

### BACKGROUND ART

Patent Literature 1 below discloses a scheduling device that forecasts a service demand at a stop-off point in consideration of a weather condition at the stop-off point.

### CITATION LIST

### Patent Literature

[Patent Literature 1] Japanese Unexamined Patent Publication No. 2017-102502

### SUMMARY OF INVENTION

### Technical Problem

However, in the above scheduling device, there is a problem that only a patterned service demand based on the weather condition can be forecasted, and a service demand cannot be flexibly forecasted.

Therefore, an aspect of the present disclosure is made in view of such a problem, and an object of the present disclosure is to provide a demand forecasting device capable of forecasting a demand more flexibly.

### Solution to Problem

In order to solve the above problems, a demand forecasting device according to an aspect of the present disclosure is a demand forecasting device for forecasting a demand in a first area, the first area being a predetermined area, the demand forecasting device including: a storage unit configured to store area information regarding a second area, the second area being a predetermined area relevant to a demand of the first area; an acquisition unit configured to acquire information on the number of people in the second area indicated by the area information stored in the storage unit; and a forecasting unit configured to forecast a demand in the first area on the basis of the information on the number of people in the area acquired by the acquisition unit.

According to such a demand forecasting device, because the demand in the first area is forecasted on the basis of information on the number of people in the second area relevant to the demand in the first area, it is possible to forecast a demand more flexibly, for example, unlike patterned demand forecasting.

### Advantageous Effects of Invention

According to an aspect of the present disclosure, it is possible to forecast a demand more flexibly.

### BRIEF DESCRIPTION OF DRAWINGS

FIG. 1 is a system configuration diagram of a demand forecasting system including a demand forecasting device according to an embodiment of the present disclosure.

FIG. 2 is a functional block diagram of the demand forecasting device according to the embodiment of the present disclosure.

FIG. 3 is a diagram illustrating an example of a first area and a second area.

FIG. 4 is a diagram illustrating an example of a table of data of the number of people in an area.

FIG. 5 is a diagram illustrating an example of a table of second area definition data.

FIG. 6 is a diagram illustrating an example of a table of learning data.

FIG. 7 is a diagram illustrating an example of a table of forecasting data.

FIG. 8 is a diagram illustrating an example of a table of aggregation data (No. 1).

FIG. 9 is a diagram illustrating an example of a table of the aggregation data (No. 2).

FIG. 10 is a diagram illustrating an example of a table of user position history data.

FIG. 11 is a diagram illustrating an example of a table of the aggregation data (No. 3).

FIG. 12 is a diagram illustrating an example of a table of user visit history data.

FIG. 13 is a diagram illustrating an example of a table of user information data.

FIG. 14 is a diagram illustrating an example of a table of user application usage history data.

FIG. 15 is a diagram illustrating an example of a table of user payment history data.

FIG. 16 is a diagram illustrating an example of a table of store position master data.

FIG. 17 is a diagram illustrating an example of a table of home departure time data.

FIG. 18 is a diagram illustrating an example of a table of SNS posting information data.

FIG. 19 is a diagram illustrating an example of a table of event information data.

FIG. 20 is a flowchart illustrating demand forecasting processing executed by the demand forecasting device according to the embodiment of the present disclosure.

FIG. 21 is a hardware configuration diagram of the demand forecasting device according to the embodiment of the present disclosure.

### DESCRIPTION OF EMBODIMENTS

Hereinafter, an embodiment of a demand forecasting device will be described in detail together with the drawings. In description of the drawings, the same elements are denoted by the same reference signs, and repeated description will be omitted. Further, embodiments in the following description are specific examples of the present disclosure, and the present disclosure is not limited to these embodiments unless there is description that the present disclosure is particularly limited.

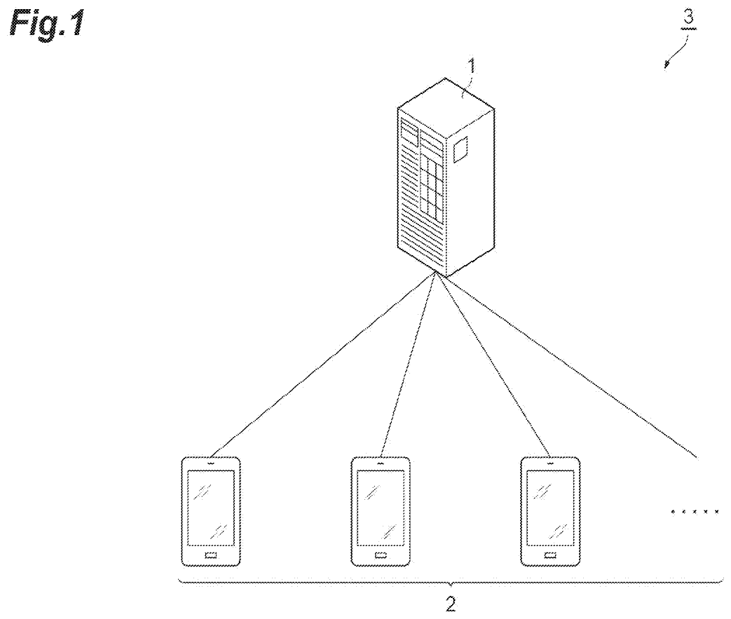

FIG. 1 is a system configuration diagram of a demand forecasting system 3 including a demand forecasting device 1 according to an embodiment of the present disclosure. As illustrated in FIG. 1, the demand forecasting system 3 includes the demand forecasting device 1 and one or more mobile terminals 2. Hereinafter, a plurality of mobile terminals 2 are also collectively referred to as a “mobile terminal 2.” The demand forecasting device 1 and each mobile terminal 2 are connected to each other via a network such as the Internet or a wireless network, and can transmit and receive information to and from each other.

The demand forecasting device 1 is a computer device such as a server device. The demand forecasting device 1 forecasts a demand in a first area, which is a predetermined area, on the basis of information received from the mobile terminal 2. The area is a range having a certain area surrounded by a rectangle, a circle, or the like, and is also called a section, a range, a region, a zone, a district, or a place. The area may be a three-dimensional range having a constant volume. The area may be a point having no area, and is also referred to as a point, a place, a spot, a position, or a base. The first area is assumed to be an area in which some demand can occur, but is not limited thereto. As an example of the first area, in the present embodiment, a restaurant that mainly provides a restaurant service is assumed, but the present disclosure is not limited thereto. The demand is a desire that is backed by purchasing power for goods or services, or a social total amount of that desire. Examples of a demand in the restaurant may include the number of customers visiting the restaurant, a sales amount, and the number of sold products. Details of a function of the demand forecasting device 1 will be described below.

The mobile terminal 2 is a computer device such as a smartphone or a notebook personal computer (PC). A user of the mobile terminal 2 carries the mobile terminal 2. The mobile terminal 2 includes a Global Positioning System (GPS) terminal, and can acquire current position information of the mobile terminal 2 (user) using the GPS terminal. The position information includes a latitude, a longitude, a positioning error, a positioning time (acquisition time when the latitude and longitude are acquired), and the like. In the present embodiment, description will be given using the position information acquired using a GPS terminal, but the present disclosure is not limited thereto, and for example, position information acquired on the basis of base station information transmitted from a base station may be used. The mobile terminal 2 appropriately transmits data acquired and processed by the mobile terminal 2 such as attribute information of a user, an application usage history of the user, a payment history of the user, and a time when the user departs from home, in addition to position information, to the demand forecasting device 1. The mobile terminal 2 can perform mobile communication via a mobile communication network of a mobile communication system.

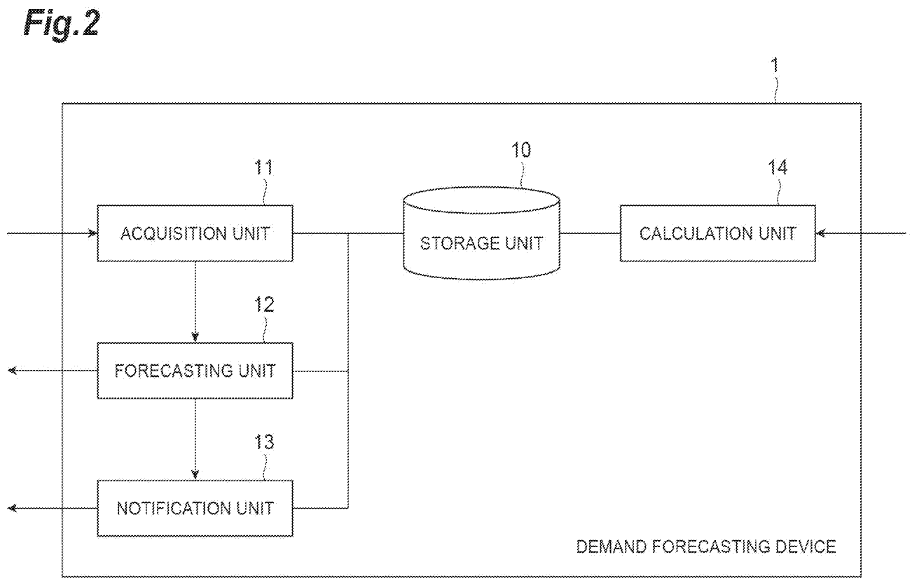

FIG. 2 is a functional block diagram of the demand forecasting device 1. As illustrated in FIG. 2, the demand forecasting device 1 includes a storage unit 10, an acquisition unit 11, a forecasting unit 12, a notification unit 13, and a calculation unit 14.

Each functional block of the demand forecasting device 1 is assumed to function in the demand forecasting device 1, but is not limited thereto. For example, some of the functional blocks of the demand forecasting device 1 are a server device different from the demand forecasting device 1, and may function while appropriately transmitting or receiving information to or from the demand forecasting device 1 in the server device connected to the demand forecasting device 1 via a network. Further, some functional blocks of the demand forecasting device 1 may be omitted. For example, one or more of the notification unit 13 and the calculation unit 14 may not be present in the demand forecasting device 1.

Hereinafter, each functional block of the demand forecasting device 1 illustrated in FIG. 2 will be described.

The storage unit 10 stores area information regarding a second area, which is a predetermined area relevant to a demand of the first area.

The second area is, for example, an area in which the number of people in the area and the demand in the first area are correlated with each other. Further, for example, the second area is an area that there is a tendency for a person visiting the first area to visit. Further, for example, the second area is an area in which a person expected to visit the first area (a person expected to visit a restaurant) is likely to be present or can be present. Further, for example, the second area is an area in which a tendency for a person visiting the first area to stay as an inflow source is (relatively) strong. Further, for example, the second area is an area in which a probability that a person visiting the first area is present is higher than a predetermined threshold value. Here, a person being in the area refers to, for example, a state in which the mobile terminal 2 carried by the person can perform mobile communication (a communication path has been established) in a cell covering the area (a section of a range in which each base station constituting the mobile communication system can perform communication). In the description of the present embodiment, the terms “being,” “visiting,” “staying,” and “passing” (as well as other parts of speech such as noun forms of all of these terms) may be appropriately used in place of one another.

In an example of the second area described above, a limitation that a person is present in an area/visits/stays before or after a predetermined time may be added. For example, the second area is an area in which the number of people in the area a predetermined time before or after a time when a demand in the first area occurs and a demand in the first area are correlated. Further, for example, the second area is an area in which there is a tendency for a person visiting the first area to visit before or after a predetermined time (relative to a time when the person visits the first area). Further, for example, the second area may be an area in which a person expected to visit the first area is likely to be before or after a predetermined time (relative to a time when the person visits the first area) or an area in which the person can be. Further, for example, the second area is an area in which a tendency for the person visiting the first area to stay before or after a predetermined time as an inflow source (relative to a time when the person visits the first area) is (relatively) strong. Further, for example, the second area is an area in which a probability that a person visiting the first area will be present in the area before or after a predetermined time (relative to a time when the person visits the first area) is higher than a predetermined threshold value.

The area information is, for example, information for specifying an area. When a region is divided into rectangular meshes with a side of about 100 m and a mesh number for specifying the mesh is assigned to each mesh, area information regarding an area may include mesh numbers of one or more meshes constituting the area. Further, for example, when the area is indicated by a range within a circle, the area information regarding the area may include a latitude and longitude of a center of the circle, and a radius of the circle. However, the area information is not limited to the above-described content, and may include any information as long as the information is information regarding the area, and may further include information not relevant to the area.

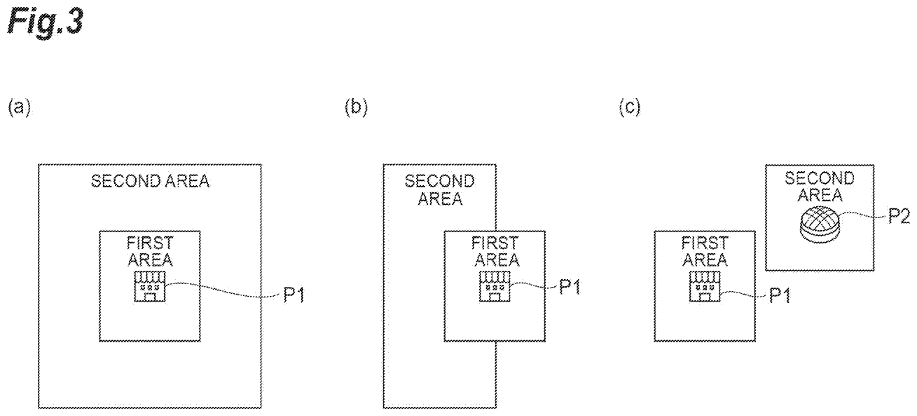

FIG. 3 is a diagram illustrating an example of the first area and the second area. As illustrated in FIG. 3(a), the first area may be an area including a demand forecasting target facility (for example, a restaurant) P1 that is a target for which the demand forecasting device 1 forecasts the demand, and the second area may be an area including the first area. Further, as illustrated in FIG. 3(b), the first area may be an area including the demand forecasting target facility P1, and the second area may be an area including a part of the first area. Further, as illustrated in FIG. 3(c), the first area may be an area including the demand forecasting target facility P1, and the second area may be an area including an event venue P2 (in which a population suddenly increases), which is an area that does not include the first area. In addition, the second area may be an area different (in range) from the first area. Further, the second area may be the same area (range) as the first area.

The storage unit 10 may store area information regarding the second area calculated by the calculation unit 14 to be described below. Further, the storage unit 10 may store information necessary for other processing, and details will be described appropriately in description below.

The acquisition unit 11 acquires information on the number of people in the second area indicated by the area information stored in the storage unit 10. The acquisition unit 11 may acquire information on the number of people in the second area in the past (a predetermined time before a present time), may acquire information on the number of people in the second area at a present time, or may acquire information on the number of people (scheduled to be) present in the second area in the future (a predetermined time after the present time). The number of people that is a source of the information on the number of people in the area acquired by the acquisition unit 11 may be acquired on the basis of geo-fence information using GPS, WiFi (registered trademark), Beacon, or the like of the mobile terminal 2, or mobile spatial statistics (registered trademark) using, for example, position registration information of the mobile terminal 2. The acquisition unit 11 outputs the acquired information on the number of people in the area to the forecasting unit 12.

A specific example of processing of the acquisition unit 11 will be described using data of the number of people in an area and second area definition data prepared in advance by the acquisition unit 11 or the demand forecasting device 1 using the related art and stored in the storage unit 10.

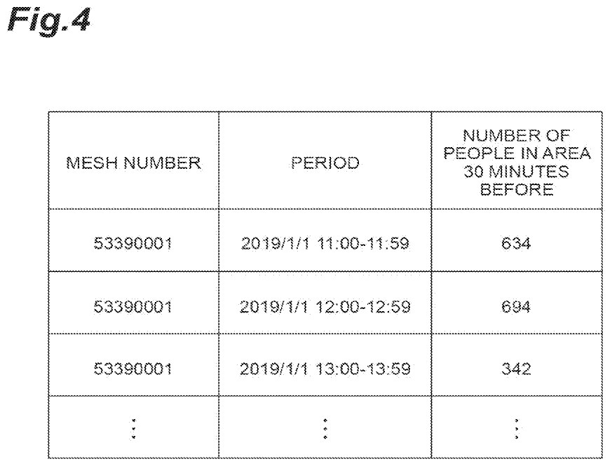

The data of the number of people in an area is data showing the number of people in the area 30 minutes before a predetermined period in each mesh. FIG. 4 is a diagram illustrating an example of a table of data of the number of people in an area. As illustrated in FIG. 4, the data of the number of people in an area includes a mesh number, a predetermined period, and the number of people in the area 30 minutes before the predetermined period (for example, a median value) in the mesh indicated by the mesh number, which are associated with each other. The acquisition unit 11 or the demand forecasting device 1 calculates the data of the number of people in the area periodically on the basis of, for example, position information (including a latitude, a longitude, and a positioning time) received from each mobile terminal 2, a mesh number, and position information of the mesh indicated by the mesh number, and stores the data in the storage unit 10.

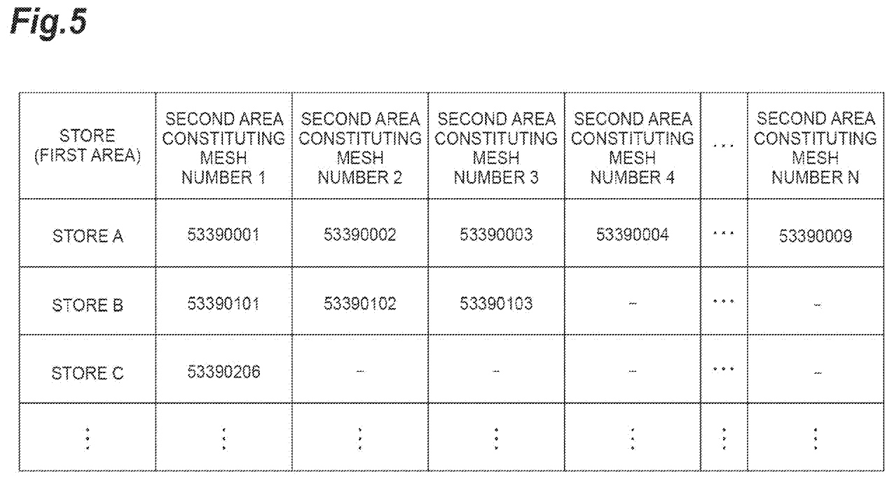

The second area definition data is data indicating the first area and meshes constituting the second area relevant to the demand of the first area. FIG. 5 is a diagram illustrating an example of a table of the second area definition data. As illustrated in FIG. 5, the second area definition data includes (a store name for identifying) a store in the first area, and mesh numbers of meshes constituting the second area relevant to the demand of the store, which are associated with each other. The acquisition unit 11 or the demand forecasting device 1 calculates the second area definition data periodically on the basis of, for example, a store designated in advance by a forecasting execution user or the like who executes demand forecasting by the demand forecasting device 1, and the second area calculated by the calculation unit 14 to be described below on the basis of the store, and stores the second area definition data in the storage unit 10. A master table for managing each of the mesh numbers of the meshes (mesh numbers 1 to N) constituting the second area is stored in advance for each store, and is appropriately used by the acquisition unit 11 or the demand forecasting device 1. Further, an input (for example, data designation and data setting) to the demand forecasting device 1 by the forecasting execution user to be described in the present embodiment is executed specifically by a terminal carried by the forecasting execution user performing an input instruction to the forecasting execution user (having the same configuration as the mobile terminal 2) and the terminal performing an input to the demand forecasting device 1 via a network on the basis of the input instruction. Similarly, an output (for example, data notification, data presentation, or data display) to the forecasting execution user by the demand forecasting device 1 to be described in the present embodiment is executed specifically by the demand forecasting device 1 performing an output instruction to the terminal carried by the forecasting execution user via a network and the terminal performing an output to the forecasting execution user on the basis of the output instruction. The terminal carried by the forecasting execution user may be included in the demand forecasting system 3.

The acquisition unit 11 extracts, for example, mesh numbers of one or more meshes constituting the second area associated with the first area in the second area definition data for the first area designated by the forecasting execution user (or set in the demand forecasting device 1 in advance), extracts the number of people in the area 30 minutes before associated with each mesh number extracted from data of the number of people in the area and a period designated by the forecasting execution user (or set in the demand forecasting device 1 in advance), and acquires a total number of people in the area as information on the number of people in the area. The information on the number of people in the area acquired here is the number of people in the area 30 minutes before the designated period in the second area relevant to the demand of the designated first area. The number of people in the area 30 minutes before is set as the data of the number of people in the area another predetermined time before or after in the data of the number of people in the area, so that the acquisition unit 11 can acquire information on the number of people in the area the other predetermined time before or after.

The forecasting unit 12 forecasts the demand in the first area on the basis of the information on the number of people in the area acquired (input) by the acquisition unit 11. For example, the forecasting unit 12 refers to data in which the number of people in the second area and the forecasted number of customers of the restaurant that is the first area are associated with each other in advance, extracts the forecasted number of customers associated with the number of people in the area indicated by the information on the number of people in the area acquired by the acquisition unit 11, and forecasts the extracted forecasted number of customers as the demand in the first area. The forecasting unit 12 outputs the forecasted demand to the notification unit 13. The forecasting unit 12 may output (display) the forecasted demand to the forecasting execution user, or may output (display) the forecasted demand to another device via a network.

The forecasting unit 12 may forecast the demand in the first area further on the basis of past information on the number of people in the second area and past demand in the first area. More specifically, the forecasting unit 12 may extract a relationship between the past information on the number of people in the second area and the past demand in the first area through machine learning or the like, and apply the information on the number of people in the area acquired by the acquisition unit 11 to the extracted relationship to forecast the demand in the first area.

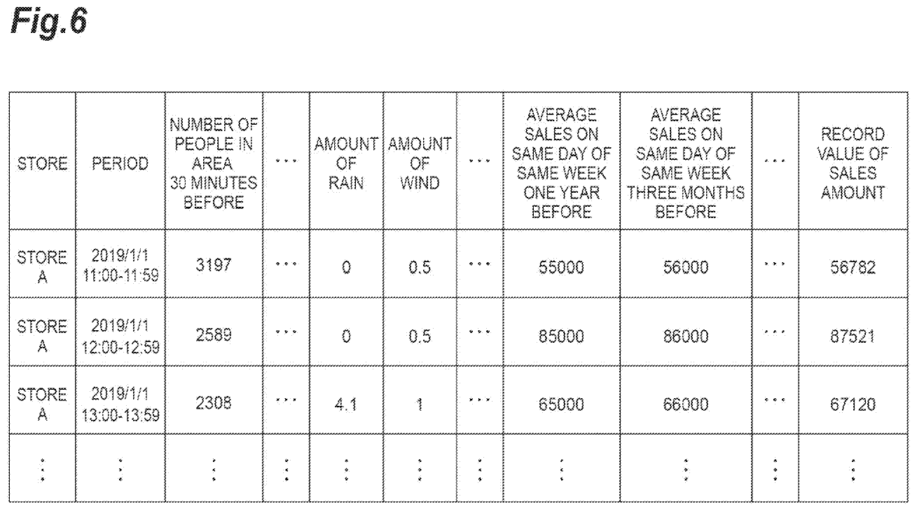

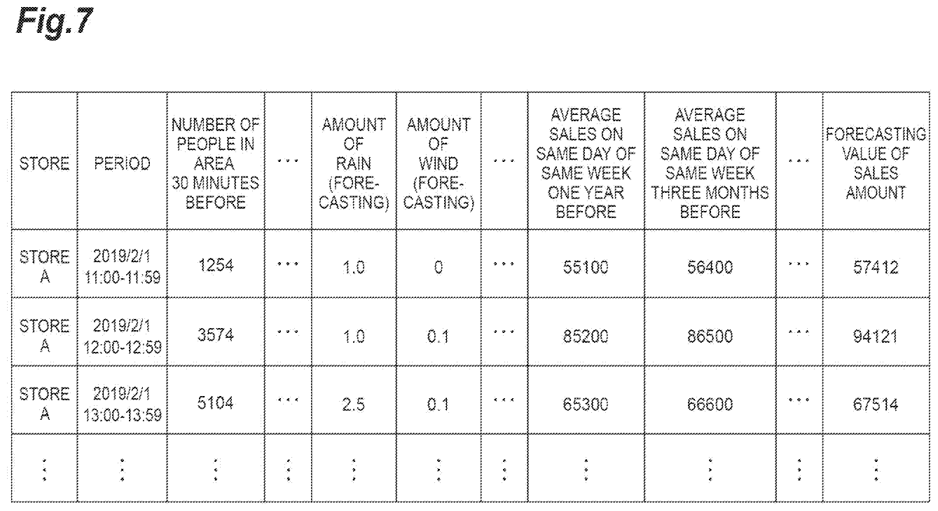

An example of demand forecasting using machine learning by the forecasting unit 12 will be described with reference to FIGS. 6 and 7. FIG. 6 is a diagram illustrating an example of a table of learning data. As illustrated in FIG. 6, the learning data includes (a store name for identifying) a store in the first area, a predetermined period, the number of people in the area 30 minutes before and after the predetermined period in the second area relevant to the demand of the store (the number of people in the second area for learning; a sum of the numbers of people in the areas in the meshes constituting the second area), an amount of rain that is weather information in the predetermined period, an amount of wind that is weather information in the predetermined period, average sales of the store on the same day of the same week one year before that is sales record statistics during the predetermined period, average sales of the store on the same day of the same week three months before that is sales record statistics during the predetermined period, and a record value of a sales amount of the store during the predetermined period, which are associated with each other. The weather information and the sales record statistics are learning feature quantities. When the weather information is not used at the time of application to be described below, the weather information is not associated in the learning data. The learning data may be periodically created by the demand forecasting device 1 and stored in the storage unit 10. The forecasting unit 12 (or the demand forecasting device 1) causes the learning data as illustrated in FIG. 6 to be subjected to machine learning to extract a relationship between the number of people in the area 30 minutes before the predetermined period and a record value of a sales amount of the store during the predetermined period.

FIG. 7 is a diagram illustrating an example of a table of forecasting data. As illustrated in FIG. 7, the forecasting data includes (a store name for identifying) a store in the first area, a predetermined period, the number of people in the area 30 minutes before and after the predetermined period in the second area relevant to the demand of the store (the number of people in the second area; a sum of the numbers of people in the areas in the meshes constituting the second area), an amount of rain that is weather information (forecast) in the predetermined period, an amount of wind that is weather information (forecast) in the predetermined period, average sales of the store on the same day of the same week one year before that is sales record statistics during the predetermined period, average sales of the store on the same day of the same week three months before that is sales record statistics during the predetermined period, and a forecasting value of a sales amount of the store during the predetermined period, which are associated with each other. The weather information and sales record statistics are feature quantities. A forecasted value of the sales amount in the forecasting data is empty before application by the forecasting unit 12. The forecasting data may be periodically created by the demand forecasting device 1 and stored in the storage unit 10. The forecasting unit 12 applies the forecasting data to the extracted relationship to calculate the record value of the sales amount, that is, forecast the demand. The forecasting unit 12 associates the calculated record value of the sales amount with the forecasting data.

The notification unit 13 notifies the forecasting execution user when a difference between the demand in the first area forecasted (input) by the forecasting unit 12 and a predetermined demand exceeds a predetermined threshold value. For example, when the sales amount (in this example, a unit of several tens of minutes to one day is assumed) in the restaurant forecasted by the forecasting unit 12 is “10000 yen,” a sales amount determined in advance by the demand forecasting device 1 or the forecasting execution user is “15000 yen,” and a predetermined threshold value is “3000 yen,” a difference “5000 yen” between the forecasted sales amount and the predetermined sales amount exceeds (is more than) the threshold value “3000 yen,” and thus the notification unit 13 notifies the forecasting execution user that the threshold value has been exceeded using an alarm sound and a warning display.

The calculation unit 14 calculates (extracts) the second area. The calculation by the calculation unit 14 may be performed periodically. Hereinafter, three specific examples of the calculation by the calculation unit 14 will be described.

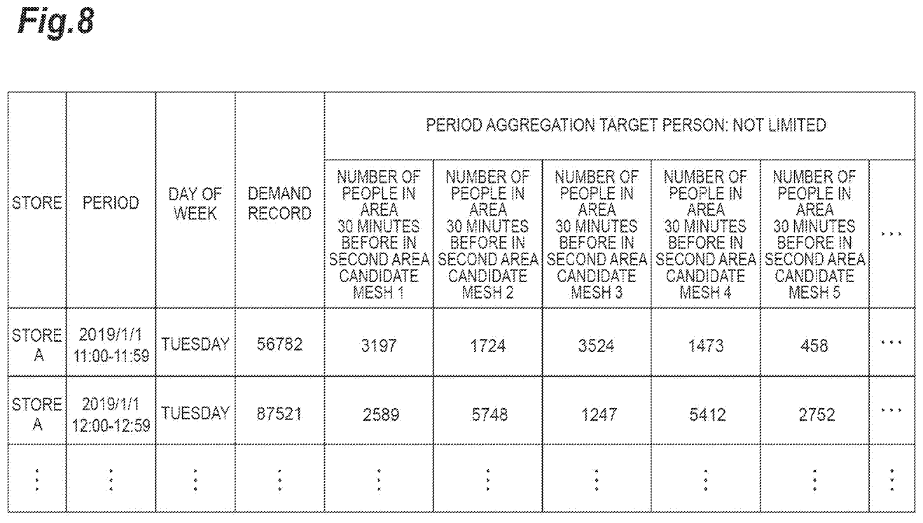

As a first specific example, the calculation unit 14 may extract an area having a strong correlation between (an increase or decrease in) a store visit demand and (an increase or decrease in) the number of people in the area a certain time before by store, by day of the week, and by time on the basis of a past store visit demand record and a past record of the number of area-specific people in the area, and calculate the extracted area as the second area relevant to the demand of the store (the first area). The calculation unit 14 uses, for example, the aggregation data illustrated in FIG. 8 at the time of extraction. As illustrated in FIG. 8, the aggregation data includes (a store name for identifying) a store in the first area, a predetermined period, a day of the week of the predetermined period, (an increase or decrease in) a store visit demand of the store in the predetermined period, and the number of people in the area 30 minutes before the predetermined period in each of meshes (meshes constituting a second area candidate), which are associated with each other. The calculation unit 14 calculates the area having a strong correlation between (an increase or decrease in) the store visit demand and (an increase or decrease in) the number of people in the area a certain time before by store in the aggregation data as the second area. The aggregation data may be periodically created by the calculation unit 14 or the demand forecasting device 1 and stored in the storage unit 10. Machine learning may be used for extraction of the correlation. The above-described fixed time is a time difference between a timing of demand forecasting of the demand forecasting device 1 and a store visit demand forecasting target period, or longer.

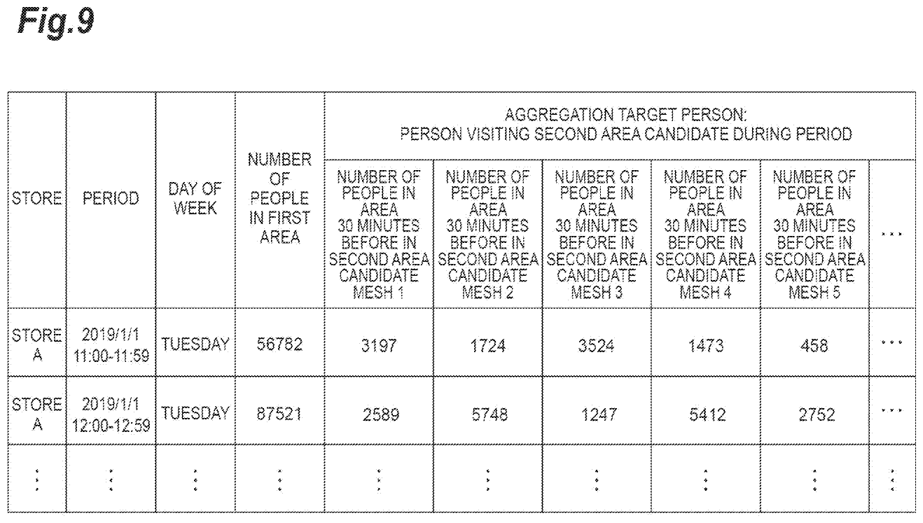

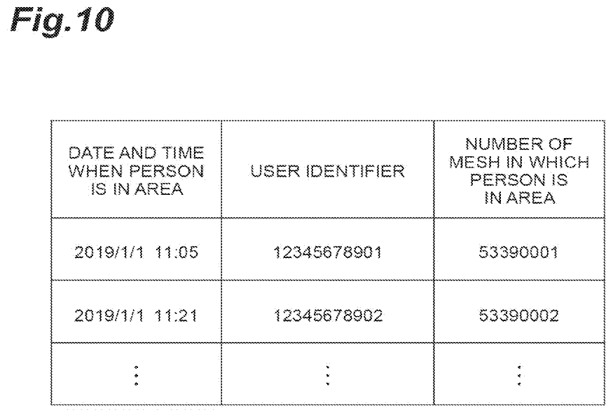

As a second specific example, the calculation unit 14 extracts an area in which a tendency for a person visiting an area near the store (an area in a predetermined distance from the store; it is not necessary to recognize whether or not the store has actually been visited) to stay a certain period of time before is strong by store, by day of the week, and by time on the basis of the past record of the number of area-specific people in the area, and calculates the extracted area as the second area associated with the demand of the store (the first area). The calculation unit 14 uses, for example, the aggregation data illustrated in FIG. 9 at the time of extraction. As illustrated in FIG. 9, the aggregation data includes (a store name for identifying) a store in the first area, a predetermined period, the day of the week in the predetermined period, the number of people in the area near the store in the predetermined period (or a user identifier for identifying a user who has visited the area near the store), and the number of people in the area 30 minutes before the predetermined period in each of meshes (meshes constituting a second area candidate) with the user as an aggregation target person, which are associated with each other. The calculation unit 14 calculates an area in the aggregation data in which a tendency to stay 30 minutes before a predetermined period is strong as the second area. The aggregation data may be periodically created by the calculation unit 14 or the demand forecasting device 1 and stored in the storage unit 10. At the time of the creation, for example, user position history data illustrated in FIG. 10 is used to determine an aggregation target person. As illustrated in FIG. 10, the user position history data includes a date and time when the user has been in the area, a user identifier for identifying a user, and a mesh number of the mesh in the area, which are associated with each other. It is assumed that in order to consider privacy or the like in aggregating the number of people in the area, concealment processing (such as removing a numerical value of a small number of people area) is performed using a method of the related art. The above-described fixed time is a time difference between a timing of demand forecasting of the demand forecasting device 1 and the store visit demand forecasting target period, or longer.

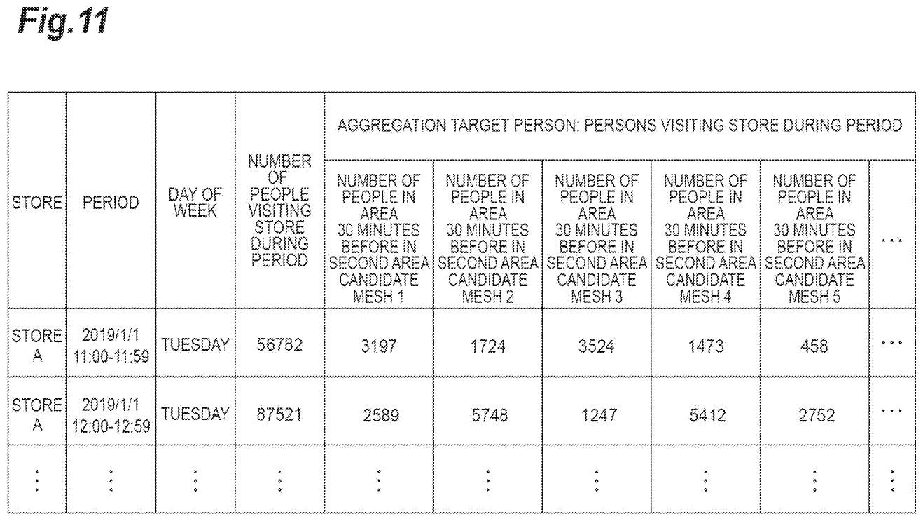

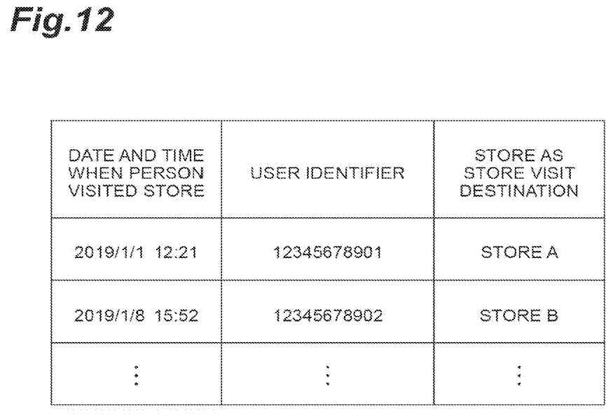

As a third specific example, the calculation unit 14 extracts an area in which a tendency to stay a certain period in which a visitor visits a target store before is strong by store, by day of the week, and by time on the basis of the past record of the number of area-specific people in the area and a past record of person-specific store visit and calculates the extracted area as a second area relevant to the demand of the store (the first area). The calculation unit 14 uses, for example, the aggregation data illustrated in FIG. 11 at the time of the extraction. As illustrated in FIG. 11, the aggregation data includes (a store name for identifying) a store in the first area, a predetermined period, a day of the week of the predetermined period, the number of visitors who have visited the store during the predetermined period (or user identifiers for identifying the visitors), and the number of people in the area 30 minutes before the predetermined period in each of meshes (meshes constituting the second area candidate) with the visitor as aggregation target persons, which are associated with each other. The calculation unit 14 calculates an area in the aggregation data in which a tendency to stay 30 minutes before a predetermined period is strong as the second area. The aggregation data may be periodically created by the calculation unit 14 or the demand forecasting device 1 and stored in the storage unit 10. At the time of the creation, for example, the user position history data illustrated in FIG. 10 and the user visit history data illustrated in FIG. 12 are used to determine the aggregation target person. As illustrated in FIG. 12, the user visit history data includes a date and time when a user has visited the store, a user identifier for identifying the user, and (a store name for identifying) a visited store, which are associated with each other. It is assumed that a visitor (a person-specific store visit record) is determined from position information of the mobile terminal 2 (including a geo-fence such as WiFi (registered trademark) or Beacon) and a payment history (including point impartment or usage history). It is assumed that in order to consider privacy or the like in aggregating the number of people in the area, concealment processing (such as removing a numerical value of a small area) is performed using a method of the related art. The above-described fixed time is a time difference between a timing of demand forecasting of the demand forecasting device 1 and the store visit demand forecasting target period, or longer.

Effects of the three specific examples of the calculation by the calculation unit 14 described above will be described. In addition to a scheme using past demand record data or weather forecasting data for forecasting of a store demand, the number of people currently present near the store is regarded as a population of the number of people likely to visit the store (the number of people expected to visit the store) and utilized for demand forecasting, so that following a sudden demand fluctuation can be expected. However, when the number of people likely to visit a store is measured, geographical features of each store is not considered and accurate measurement cannot be expected in a method of measuring the number of people in a uniform area such as “an area with a radius of 500 m centered on the store”. For example, in store A, there are many offices on the east side and there are many visits from the same area during a lunch time on weekdays, whereas there are few visits from the same area on holidays and there are many visits from a shopping district area on the west side. In the specific example described above, an area in which many people expected to visit the store are distributed is extracted in advance for each store by day and by time, and the number of people expected to visit the store is calculated on the basis of the number of people in the area at the time of store demand forecasting and used for store demand forecasting, so that more accurate store demand forecasting can be realized. Further, a target area in which the number of people in the area is input to store demand forecasting processing so that an effect of curbing of a calculation amount of the forecasting processing can be expected.

The acquisition unit 11 may acquire information on the number of people in the area for each attribute (segment) of people in the second area. In this case, the forecasting unit 12 forecasts the demand in the first area on the basis of the information on the number of people in the second area for each attribute of people in the area acquired by the acquisition unit 11. The attribute may be an attribute that has a correlation (a strong correlation) with the demand in the first area (by store, by day of the week, and by time). In this case, the acquisition unit 11 may give more weight to the number of people having the correlated attribute (as compared to an uncorrelated attribute). Using the attribute, the demand forecasting device 1 emphasizes an attribute at which a person is more strongly expected to visit the store among the people currently present in the area, who are expected to visit the store, and belittles an attribute at which a person is less expected to visit the store to calculate the number of people and uses the number of people for store demand forecasting, so that more accurate store demand forecasting can be realized.

Examples of the attribute may include a gender, age, place of residence, occupation, hobbies and tastes, lifestyle, presence or absence of an eating out tendency for each of lunch and dinner, and a time of departure from the place of residence (it is possible to determine whether or not a meal has been completed depending on whether or not a target person leaves home before a lunch and dinner time period, and to extract attributes at which the meal is highly likely not to have been completed) of the target person. The acquisition unit 11 or the demand forecasting device 1 may infer attributes from a position history, application usage history, payment history, and the like of the target person. The acquisition unit 11 or the demand forecasting device 1 may determine whether or not there is the eating out tendency, which is an attribute, on the basis of a distance from a place of residence of the target person to a location of the target store (when the distance is smaller, the eating out tendency is low and when the distance is larger, the eating out tendency is high). The acquisition unit 11 or the demand forecasting device 1 may calculate a relationship between a distance from the place of residence to the store and a strength of the eating out tendency for each region in advance, and switch between criteria for a determination as to whether or not there is the eating out tendency for each region on the basis of the relationship. The acquisition unit 11 or the demand forecasting device 1 may calculate a relationship between a distance from the place of residence to the store and a strength of the eating out tendency for each person in advance, and switch between criteria for a determination as to whether or not there is the eating out tendency for each person on the basis of the relationship.

When the attribute is used, the forecasting unit 12 may forecast the demand in the first area on the basis of a degree of deviation from a normal time of a “composition ratio of information on the number of people in the area for each attribute”. Accordingly, it is ascertained from a change in a composition ratio for each attribute that an event or the like difficult to ascertain from the number of people currently present in an area in which the people are expected to visit occurs near the store, and this is used for store demand forecasting, so that more accurate store demand forecasting can be realized. For example, when many of residents are out on consecutive holidays, whereas many tourists are visiting, the number of people in an area is not much different from a usual number, but a composition ratio of attributes for each place of residence is greatly different from a normal composition ratio.

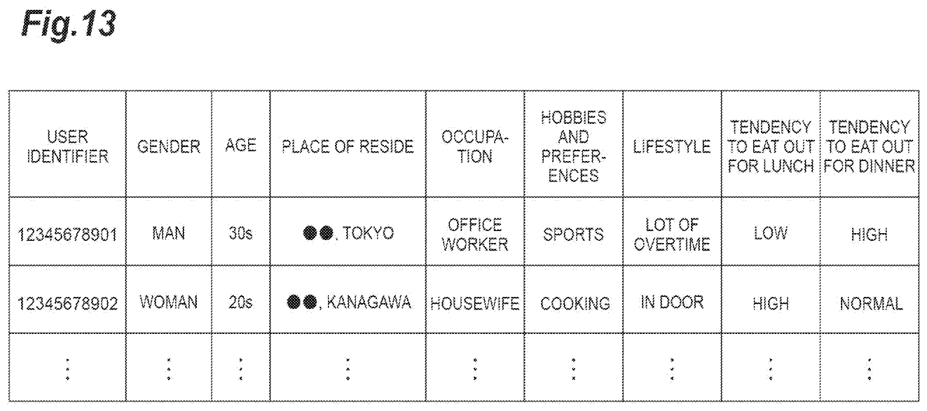

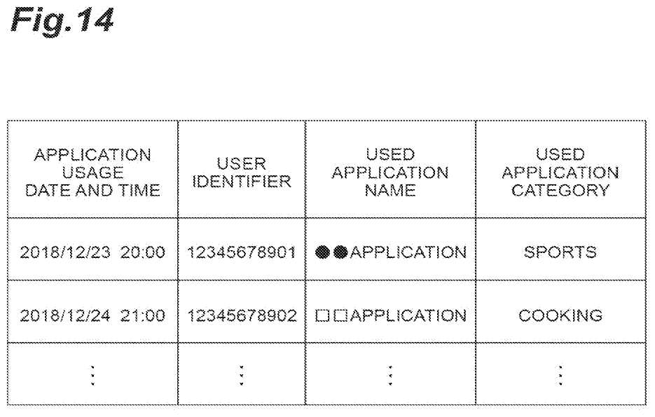

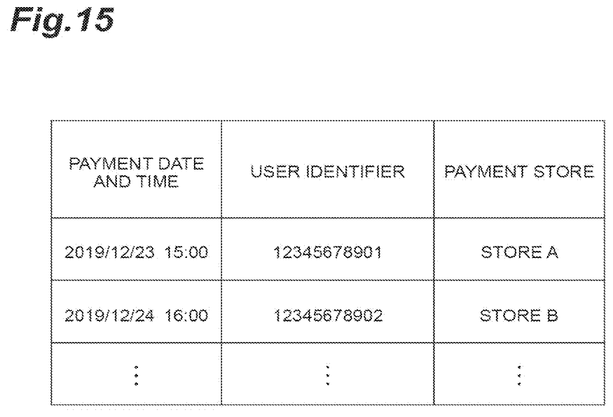

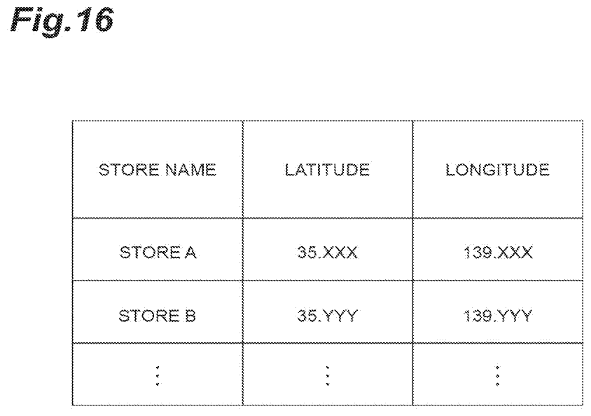

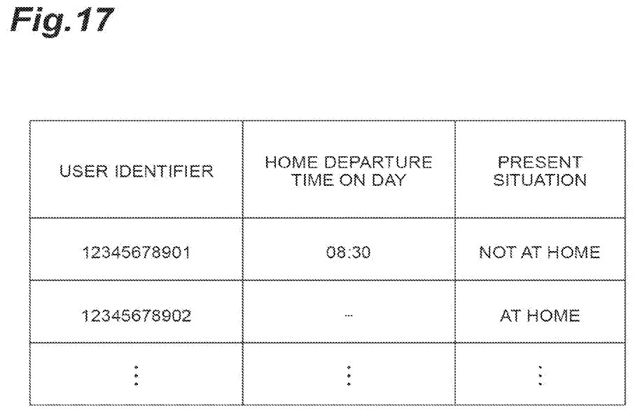

When the acquisition unit 11, the forecasting unit 12, or the demand forecasting device 1 performs processing regarding attributes, the acquisition unit 11, the forecasting unit 12, or the demand forecasting device 1 appropriately uses the user position history data (described above), the user visit history data (described above), a user information table, user application usage history data, user payment history data, store position master data, and home departure time data, and performs processing using the related art. FIG. 13 is a diagram illustrating an example of a table of user information data. As illustrated in FIG. 13, the user information data includes a user identifier, a gender of the user identified by the user identifier, an age of the user, a place of residence of the user, an occupation of the user, hobbies and preferences of the user, a lifestyle of the user, a tendency for the user to eat out for lunch, and a tendency for the user to eat out for dinner, which are associated with each other. FIG. 14 is a diagram illustrating an example of a table of user application usage history data. As illustrated in FIG. 14, the user application usage history data includes an application usage date and time when a user has used an application, a user identifier for identifying the user, a used application name of an application, and a used application category of the application, which are associated with each other. FIG. 15 is a diagram illustrating an example of a table of user payment history data. As illustrated in FIG. 15, the user payment history data includes a payment date and time when the user makes a payment at a store, a user identifier for identifying the user, and a payment store that is the store, which are associated with each other. FIG. 16 is a diagram illustrating an example of a table of store position master data. As illustrated in FIG. 16, the store position master data includes a store name of a store, a latitude in which the store is located, and a longitude in which the store is located, which are associated with each other. FIG. 17 is a diagram illustrating an example of a table of home departure time data. As illustrated in FIG. 17, the home departure time data includes a user identifier, a home departure time on the day of the user identified by the user identifier, and a present situation of the user, which are associated with each other.

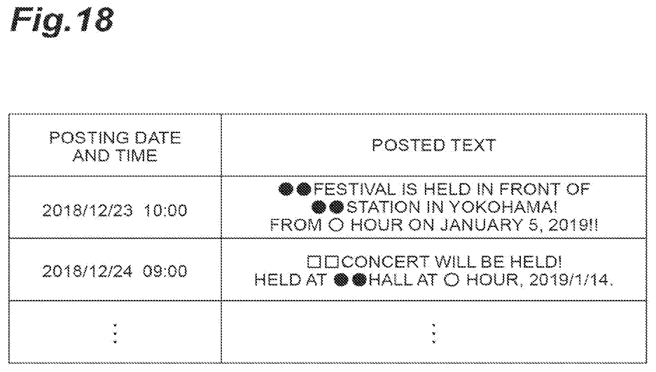

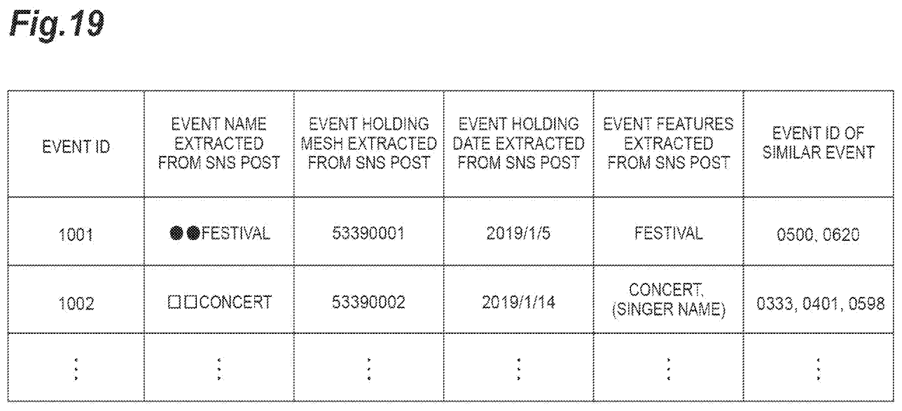

The acquisition unit 11 may acquire information on the number of people in the area regarding the forecasted number of people forecasted to be in the second area. Further, the acquisition unit 11 may acquire the forecasted number of people in a past period (stored in the storage unit 10 in advance) similar in features to a target period for demand forecasting, and the information on the number of people in the area regarding the forecasted number of people. The acquisition unit 11 may perform a determination on the basis of information on an event held in a period posted on a social networking service (SNS) as a determination criterion for a similarity of the features. When the acquisition unit 11 or the demand forecasting device 1 performs processing regarding the determination of the similarity, the acquisition unit 11 or the demand forecasting device 1 appropriately uses SNS posting information data and event information data and then performs processing using the related art. FIG. 18 is a diagram illustrating an example of a table of the SNS posting information data. As illustrated in FIG. 18, the SNS posting information data includes a posting date and time when posting to the SNS occurs and posted text that are associated with each other. FIG. 19 is a diagram illustrating an example of a table of the event information data. As illustrated in FIG. 19, the event information data includes an event ID for identifying an event, an event name of the event extracted from an SNS post, an event holding mesh for identifying a mesh in which the event is held, which is extracted from the SNS post, an event holding date in which the event is held, which is extracted from the SNS post, event features of the event extracted from the SNS post, and an event ID of an event similar to the event that are associated with each other.

When a current number of people in the area likely to visit the store is used for store demand forecasting, the forecasting target may be limited to one to several hours later in which a correlation between the current number of people in the area and the store demand can be expected, and there is a problem that it is difficult to forecast future store demand. As described above, in the demand forecasting device 1, held event information of a future day posted on the SNS, for example, is used to forecast the number of people likely to visit a store on the future day, and the forecasted number of people is used to perform store demand forecasting, so that store demand forecasting in future more than one to several hours later can be realized. Further, a day when similar held event information was posted on SNS in the past is specified and a record of the number of people in an area in which store visit is expected on that day is used so that the number of people likely to visit the store on the future day can be calculated more accurately.

The acquisition unit 11 may acquire the information on the number of people in the area input from the forecasting execution user. Further, the acquisition unit 11 may acquire information on the number of people in the area based on several stages (example: five stages of 1 to 5) for each unit time (example: one hour) input from the forecasting execution user. How much the number of people in the second area increases or decreases relative to a normal number is assumed for each unit time on the basis of the event information of the future day that the forecasting execution user (or the store operator) ascertains as knowledge and the assumption is input so that the demand forecasting device 1 can forecast the store demand on the basis of the assumption. Further, the forecasting execution user can input a plurality of assumed assumptions, confirm a plurality of forecasting results of a store demand, and utilize the forecasting results for preparation.

The acquisition unit 11 or the demand forecasting device 1 groups past days with a similar transition of the number of people in the second area through time-series clustering, and presents a list of groups to the forecasting execution user as an option together with a representative value of the transition of the number of people in the second area (for example, average value) and a date of the past day belonging to the same group, and the acquisition unit 11 may set the number of people in the area in the demand forecasting target period on the basis of the option, and acquire information on the number of people in the area regarding the set number of people in the area. When how much the number of people in the second area increases or decreases relative to a normal number is assumed for each unit time on the basis of the event information of the future day that the forecasting execution user (or the store operator) ascertains as knowledge, a transition of the number of people on the past similar event holding date is presented as reference information by the acquisition unit 11 or the demand forecasting device 1, so that the store operator can make a more accurate assumption and perform an input, and as a result, it is possible to obtain a more useful store demand forecasting result.

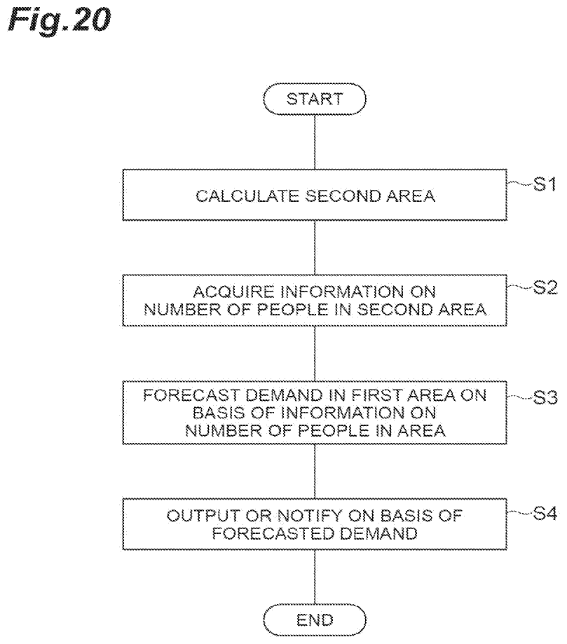

Subsequently, the demand forecasting processing of the method in the demand forecasting device 1 according to the present embodiment will be described with reference to a flowchart illustrated in FIG. 20.

First, the calculation unit 14 calculates the second area relevant to the demand of the first area, which is a demand forecasting target (step S1). Then, the acquisition unit 11 acquires the information on the number of people in the second area calculated in S1 (step S2). Then, the forecasting unit 12 forecasts the demand in the first area on the basis of the information on the number of people in the area acquired in S2 (step S3). Then, the output by the forecasting unit 12 or the notification by the notification unit 13 is performed on the basis of the demand forecasted in S3 (step S4). When the second area is required in advance, the processing of S1 may be omitted.

Next, acting effects of the demand forecasting device 1 configured as in the present embodiment will be described.

The demand forecasting device 1 includes a storage unit 10 that stores area information regarding the second area relevant to the demand of the first area, an acquisition unit 11 that acquires information on the number of people in the second area indicated by the area information stored in the storage unit 10, and a forecasting unit 12 that forecasts the demand in the first area on the basis of the information on the number of people in the area acquired by the acquisition unit 11. According to such a demand forecasting device 1, because the demand in the first area is forecasted on the basis of the information on the number of people in the second area relevant to the demand in the first area, for example, this differs from patterned forecasting of the demand and it is possible to forecast the demand more flexibly.

The second area may be an area in which the number of people in the area and the demand in the first area are correlated with each other. Further, the calculation unit 14 may calculate the second area, which is an area in which the number of people in the area and the demand in the first area are correlated with each other. According to such a demand forecasting device 1, because the number of people in the second area and the demand in the first area are correlated with each other, it is possible to forecast the demand in the first area more accurately on the basis of the information on the number of people in the second area.

The second area may be an area in which there is a tendency for people visiting the first area to visit. Further, the calculation unit 14 may calculate the second area, which is an area in which there is a tendency for a person visiting the first area to visit. According to such a demand forecasting device 1, it is possible to forecast the demand in the first area more accurately on the basis of the information on the number of people in the second area in which there is a tendency for people visiting the first area to visit.

The demand forecasting device 1 may further include the calculation unit 14 that calculates the second area, and the storage unit 10 may store area information regarding the second area calculated by the calculation unit 14. According to such a demand forecasting device 1, because the second area can be calculated at any situation and timing and the demand in the first area can be forecasted on the basis of the calculated second area, it is possible to forecast the demand more flexibly.

The acquisition unit 11 of the demand forecasting device 1 may acquire information on the number of people for each attribute of people in the second area. According to such a demand forecasting device 1, it is possible to forecast more accurate demand in consideration of the attributes of people in the second area.

The attribute may be an attribute that correlates with the demand in the first area. According to such a demand forecasting device 1, it is possible to forecast more accurate demand in consideration of an attribute that correlates with the demand in the first area.

The acquisition unit 11 of the demand forecasting device 1 may acquire information on the number of people in the area regarding the forecasted number of people forecasted to be in the second area. According to such a demand forecasting device 1, it is possible to forecast the demand more flexibly, such as to forecast a more future demand.

The acquisition unit 11 of the demand forecasting device 1 may acquire the information on the number of people in the area input from the user (forecasting execution user). According to such a demand forecasting device 1, it is possible to forecast the demand more flexibly, such as, to forecast the demand based on knowledge and experience of the user (forecasting execution user).

The forecasting unit 12 of the demand forecasting device 1 may forecast the demand in the first area further on the basis of the past information on the number of people in the second area and the past demand in the first area. According to such a demand forecasting device 1, it is possible to forecast more accurate demand on the basis of past information (record).

The notification unit 13 that notifies a user (forecasting execution user) when a difference between the demand in the first area forecasted by the forecasting unit 12 of the demand forecasting device 1 and the predetermined demand exceeds the predetermined threshold value may be further included. According to such a demand forecasting device 1, convenience is improved for the user (forecasting execution user). For example, the user (forecasting execution user) can immediately notice an abnormality, and thereby can take immediate action regarding store operation or the like.

Here, with the related art, only patterned store demand based on a date and time information (season, day of the week, time, or the like) and weather information can be forecasted, and it is difficult for store demand to be forecasted in irregular cases due to events or unexpected events. In the demand forecasting device 1 according to the present embodiment, the second area (an area in which store visit is expected) in which it is easy for an expected visitor of the target store (the first area) to be in the area is extracted, the number of people present (or who can be present) in the second area is estimated from the position information of the mobile terminal 2, and a future store demand is forecasted using the information. According to such a demand forecasting device 1, it is possible to forecast store demand in an irregular case with high accuracy.

The block diagrams used in the description of the embodiment show blocks in units of functions. These functional blocks (components) are realized in any combination of at least one of hardware and software. Further, a method of realizing each functional block is not particularly limited. That is, each functional block may be realized using one physically or logically coupled device, or may be realized by connecting two or more physically or logically separated devices directly or indirectly (for example, using a wired scheme, a wireless scheme, or the like) and using such a plurality of devices. The functional block may be realized by combining the one device or the plurality of devices with software.

The functions include judging, deciding, determining, calculating, computing, processing, deriving, investigating, searching, confirming, receiving, transmitting, outputting, accessing, resolving, selecting, choosing, establishing, comparing, assuming, expecting, regarding, broadcasting, notifying, communicating, forwarding, configuring, reconfiguring, allocating, mapping, assigning, or the like, but the present disclosure is not limited thereto. For example, a functional block (a component) that functions for transmission is referred to as a transmitting unit or a transmitter. In any case, a realizing method is not particularly limited, as described above.

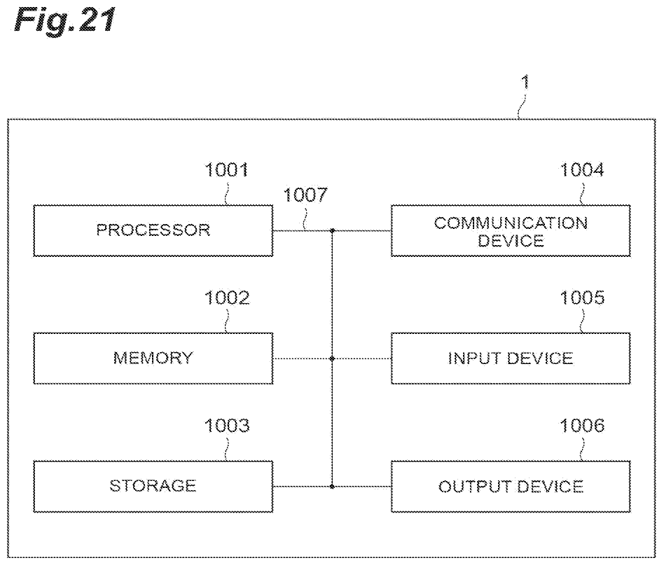

For example, the demand forecasting device 1 in the embodiment of the present disclosure may function as a computer that performs the demand forecasting processing of the present disclosure. FIG. 21 is a diagram illustrating an example of a hardware configuration of the demand forecasting device 1 according to the embodiment of the present disclosure. The demand forecasting device 1 described above may be physically configured as a computer device including a processor 1001, a memory 1002, a storage 1003, a communication device 1004, an input device 1005, an output device 1006, a bus 1007, and the like.

In the following description, the term “device” can be read as a circuit, a device, a unit, or the like. The hardware configuration of the demand forecasting device 1 may be configured to include one or a plurality of illustrated devices or may be configured without including some of the devices.

Each function in the demand forecasting device 1 is realized by loading predetermined software (a program) into hardware such as the processor 1001 or the memory 1002 so that the processor 1001 performs calculation to control communication that is performed by the communication device 1004 or reading and/or writing of data in the memory 1002 and the storage 1003.

The processor 1001, for example, operates an operating system to control the entire computer. The processor 1001 may be configured as a central processing unit (CPU) including an interface with a peripheral device, a control device, a calculation device, a register, and the like. For example, the acquisition unit 11, the forecasting unit 12, the notification unit 13, the calculation unit 14, and the like described above may be realized by the processor 1001.

Further, the processor 1001 reads a program (program code), a software module, or data from at least one of the storage 1003 and the communication device 1004 into the memory 1002 and executes various processes according to the program, the software module, or the data. As the program, a program for causing the computer to execute at least some of the operations described in the above embodiment may be used. For example, the acquisition unit 11, the forecasting unit 12, the notification unit 13, and the calculation unit 14 may be realized by a control program stored in the memory 1002 and operating in the processor 1001, and other functional blocks may be similarly realized. Although the case in which the various processes described above are executed by one processor 1001 has been described, the processes may be executed simultaneously or sequentially by two or more processors 1001. The processor 1001 may be implemented by one or more chips. The program may be transmitted from a network via an electric communication line.

The memory 1002 is a computer-readable recording medium and may be configured of, for example, at least one of a read only memory (ROM), an erasable programmable ROM (EPROM), an electrically erasable programmable ROM (EEPROM), and a random access memory (RAM). The memory 1002 may be referred to as a register, a cache, a main memory (a main storage device), or the like. The memory 1002 can store an executable program (program code), software modules, and the like in order to implement a wireless communication method according to the embodiment of the present disclosure.

The storage 1003 is a computer-readable recording medium and may be configured of, for example, at least one of an optical disc such as a compact disc ROM (CD-ROM), a hard disk drive, a flexible disc, a magneto-optical disc (for example, a compact disc, a digital versatile disc, or a Blu-ray (registered trademark) disc), a smart card, a flash memory (for example, a card, a stick, or a key drive), a floppy (registered trademark) disk, a magnetic strip, and the like. The storage 1003 may be referred to as an auxiliary storage device. The storage medium described above may be, for example, a database including at least one of the memory 1002 and the storage 1003, a server, or another appropriate medium.

The communication device 1004 is hardware (a transmission and reception device) for performing communication between computers via a wired network and a wireless network and is also referred to as a network device, a network controller, a network card, or a communication module, for example. The communication device 1004 may include, for example, a high frequency switch, a duplexer, a filter, and a frequency synthesizer in order to realize at least one of frequency division duplex (FDD) and time division duplex (TDD). For example, the acquisition unit 11, the forecasting unit 12, the notification unit 13, the calculation unit 14, and the like described above may be realized by the communication device 1004.

The input device 1005 is an input device (for example, a keyboard, a mouse, a microphone, a switch, a button, or a sensor) that receives an input from the outside. The output device 1006 is an output device (for example, a display, a speaker, or an LED lamp) that performs output to the outside. The input device 1005 and the output device 1006 may have an integrated configuration (for example, a touch panel).

Further, each device such as the processor 1001 and the memory 1002 is connected by the bus 1007 for communicating information. The bus 1007 may be configured by using a single bus, or may be configured by using a different bus for each device.

Further, the demand forecasting device 1 may include hardware such as a microprocessor, a digital signal processor (DSP), an application specific integrated circuit (ASIC), a programmable logic device (PLD), and a field programmable gate array (FPGA), and some or all of respective functional blocks may be realized by the hardware. For example, the processor 1001 may be implemented using at least one of these pieces of hardware.

Notification of information is not limited to the aspect or embodiment described in the present disclosure, and may be performed by using another method.

Each aspect or embodiment described in the present disclosure may be applied to at least one of long term evolution (LTE), LTE-Advanced (LTE-A), SUPER 3G, IMT-Advanced, 4th generation mobile communication system (4G), 5th generation mobile communication system (5G), future radio access (FRA), new radio (NR), W-CDMA (registered trademark), GSM (registered trademark), CDMA2000, ultra mobile broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), another system using an appropriate system, and a next generation system extended on the basis of these. Further, a plurality of systems may be combined (for example, a combination of at least one of LTE and LTE-A and 5G) and applied.

A process procedure, a sequence, a flowchart, and the like in each aspect/embodiment described in the present disclosure may be in a different order unless inconsistency arises. For example, for the method described in the present disclosure, elements of various steps are presented in an exemplary order, and the elements are not limited to the presented specific order.

In the present disclosure, a specific operation performed by the base station may be performed by an upper node thereof in some cases. It is obvious that in a network including one or a plurality of network nodes each having a base station, various operations performed for communication with a terminal are performed by at least one of the base station and another network node (such as an MMDE or S-GW, but the present disclosure is not limited thereto) other than the base station. Although a case in which there is one network node other than the base station has been illustrated above, there may be a combination of a plurality of other network nodes (for example, MME and S-GW).

Input or output information or the like may be stored in a specific place (for example, a memory) or may be managed in a management table. Information or the like to be input or output can be overwritten, updated, or additionally written. Output information or the like may be deleted. Input information or the like may be transmitted to another device.

A determination may be performed using a value (0 or 1) represented by one bit, may be performed using a Boolean value (true or false), or may be performed through a numerical value comparison (for example, comparison with a predetermined value).

Each aspect/embodiment described in the present disclosure may be used alone, may be used in combination, or may be used by being switched according to the execution. Further, a notification of predetermined information (for example, a notification of “being X”) is not limited to being made explicitly, and may be made implicitly (for example, a notification of the predetermined information is not made).

Although the present disclosure has been described above in detail, it is obvious to those skilled in the art that the present disclosure is not limited to the embodiments described in the present disclosure. The present disclosure can be implemented as modified and changed aspects without departing from the spirit and scope of the present disclosure defined by the description of the claims. Therefore, the description of the present disclosure is intended for exemplification, and does not have any restrictive meaning with respect to the present disclosure.

Software should be construed widely so that the software means an instruction, an instruction set, a code, a code segment, a program code, a program, a sub-program, a software module, an application, a software application, a software package, a routine, a sub-routine, an object, an executable file, a thread of execution, a procedure, a function, and the like regardless of whether the software may be called software, firmware, middleware, microcode, or hardware description language or called another name.

Further, software, instructions, information, and the like may be transmitted and received via a transmission medium. For example, when software is transmitted from a website, a server, or another remote source using at least one of a wired technology (a coaxial cable, an optical fiber cable, a twisted pair, a digital subscriber line (DSL, and the like)) and a wireless technology (infrared rays, microwaves, and the like), the at least one of the wired technology and a wireless technology is included in the definition of the transmission medium.

The information, signals, and the like described in the present disclosure may be represented using any of various different technologies. For example, data, an instruction, a command, information, a signal, a bit, a symbol, a chip, and the like that can be referred to throughout the above description may be represented by a voltage, a current, an electromagnetic wave, a magnetic field or a magnetic particle, an optical field or a photon, or any combination of these.

The terms described in the present disclosure and/or terms necessary for understanding of the present disclosure may be replaced by terms having the same or similar meanings.

The terms “system” and “network” used in the present disclosure are used interchangeably.

Further, information, parameters, and the like described in the present disclosure may be represented by an absolute value, may be represented by a relative value from a predetermined value, or may be represented by corresponding different information.

In the present disclosure, terms such as a “base station (BS)”, a “wireless base station”, a “fixed station”, “NodeB”, “eNodeB (eNB)”, “gNodeB (gNB)”, an “access point”, a “transmission point”, a “reception point”, a “transmission and reception point”, a “cell”, a “sector”, a “cell group”, a “carrier”, and a “component carrier” can be used interchangeably. The base station is also referred to by a term such as a macrocell, a small cell, a femtocell, and a picocell.

The base station can accommodate one or a plurality of (for example, three) cells. When the base station accommodates the plurality of cells, an entire coverage area of the base station can be divided into a plurality of smaller areas, and each smaller area can also provide a communication service using a base station subsystem (for example, a small indoor base station (RRH: Remote Radio Head)). The term “cell” or “sector” refers to a part or all of a coverage area of at least one of a base station and a base station subsystem that perform a communication service in this coverage.

In the present disclosure, terms such as the mobile terminal 2, a “mobile station (MS)”, a “user terminal”, a “user device (UE: User Equipment)”, and a “terminal” can be used interchangeably.

The mobile station may also be referred to as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or any other appropriate term according to those skilled in the art.

At least one of the base station and the mobile station may be called a transmission device, a reception device, a communication device, or the like. At least one of the base station and the mobile station may be a device mounted on a mobile body, the mobile body itself, or the like. The moving body may be a vehicle (for example, a car or an airplane), may be an unmanned moving body (for example, a drone or an autonomous vehicle), or may be a robot (manned or unmanned type). At least one of the base station and the mobile station includes a device that does not necessarily move at the time of a communication operation. For example, at least one of the base station and the mobile station may be an Internet of Things (IoT) device such as a sensor.

Further, the base station in the present disclosure may be read as a user terminal. For example, each aspect or embodiment of the present disclosure may be applied to a configuration in which communication between the base station and the user terminal is replaced with communication between a plurality of user terminals (which may be called, for example, device-to-device (D2D) or vehicle-to-everything (V2X)).

Similarly, the mobile terminal 2 in the present disclosure may be read as a base station. In this case, the base station may have functions of the mobile terminal 2 described above.

The term “determining” used in the present disclosure may include a variety of operations. The “determining” can include, for example, regarding judging, calculating, computing, processing, deriving, investigating, searching (looking up or inquiry) (for example, looking up in a table, a database or another data structure), or ascertaining as “determining”. Further, “determining” can include, for example, regarding receiving (for example, receiving information), transmitting (for example, transmitting information), inputting, outputting, or accessing (for example, accessing data in a memory) as “determining”. Further, “determining” can include regarding resolving, selecting, choosing, establishing, comparing or the like as “determining”. That is, “determining” can include regarding a certain operation as “determining”. Further, “determining” may be read as “assuming”, “expecting”, “considering”, or the like.

The terms “connected”, “coupled”, or any modification thereof means any direct or indirect connection or coupling between two or more elements, and can include the presence of one or more intermediate elements between two elements “connected” or “coupled” to each other. The coupling or connection between elements may be physical, may be logical, or may be a combination thereof. For example, “connection” may be read as “access.” When used in the present disclosure, two elements can be considered to be “connected” or “coupled” to each other by using at least one of one or more wires, cables, and printed electrical connections, and by using electromagnetic energy having wavelengths in a radio frequency region, a microwave region, and a light (both visible and invisible) region as some non-limiting and non-comprehensive examples.

The description “based on” used in the present disclosure does not mean “based only on” unless otherwise noted. In other words, the description “based on” means both of “based only on” and “at least based on”.

Any reference to elements using designations such as “first” and “second” as used in this disclosure does not generally limit an amount or order of those elements. These designations can be used in the present disclosure as a convenient way to distinguish between two or more elements. Thus, the reference to the first and second elements does not mean that only two elements can be adopted or that the first element has to precede the second element in some way.

When “include”, “including” and variations thereof are used in the present disclosure, those terms are intended to be comprehensive like the term “comprising”. Further, the term “or” used in the present disclosure is intended not to be an exclusive OR.

In the present disclosure, for example, when an article such as a, an, and the in English is added by translation, the present disclosure may include that a noun following such an article is plural.

In the present disclosure, a sentence “A and B differ” may mean that “A and B are different from each other.” The sentence may mean that “each of A and B is different from C.” Terms such as “separate”, “coupled”, and the like may also be interpreted, similar to “different.”

### REFERENCE SIGNS LIST

1: Demand forecasting device
2: Mobile terminal
3: Demand forecasting system
10: Storage unit
11: Acquisition unit
12: Forecasting unit
13: Notification unit
14: Calculation unit

1: A demand forecasting device for forecasting a demand in a first area, the first area being a predetermined area, the demand forecasting device comprising processing circuitry configured to:
store area information regarding a second area, the second area being a predetermined area relevant to a demand of the first area;
acquire information on the number of people in the second area indicated by the stored area information; and
forecast a demand in the first area on the basis of the acquired information on the number of people in the area.

2: The demand forecasting device according to claim 1, wherein the second area is an area in which the number of people in the area and the demand in the first area are correlated with each other.

3: The demand forecasting device according to claim 1, wherein the second area is an area in which there is a tendency for people visiting the first area to visit.

4: The demand forecasting device according to claim 1, wherein the processing circuitry further
configured to calculate the second area,
wherein the processing circuitry stores area information regarding the calculated second area.

5: The demand forecasting device according to claim 1, wherein the processing circuitry acquires information on the number of people in the second area for each attribute.

6: The demand forecasting device according to claim 5, wherein the attribute is an attribute correlated with the demand in the first area.

7: The demand forecasting device according to claim 1, wherein the processing circuitry acquires information on the number of people in the area regarding the forecasted number of people forecasted to be in the second area.

8: The demand forecasting device according to claim 1, wherein the processing circuitry acquires information on the number of people in the area input by a user.

9: The demand forecasting device according to claim 1, wherein the processing circuitry forecasts the demand in the first area further on the basis of past information on the number of people in the second area and past demand in the first area.

10: The demand forecasting device according to claim 1, wherein the processing circuitry further configured to notify a user when a difference between the forecasted demand in the first area and a predetermined demand exceeds a predetermined threshold value.

11: The demand forecasting device according to claim 2, wherein the second area is an area in which there is a tendency for people visiting the first area to visit.
